(19) United States
(12) Patent Application Publication
(10) Pub. No.: US 2019/0230674 A1
(43) Pub. Date: Jul. 25, 2019

(54) ADJUSTABLE MCS-BASED SCHEDULING OF WIRELESS RESOURCES

(71) Applicant: Qualcomm Incorporated, San Diego, CA (US)

(72) Inventors: Chao Cheng, Santa Clara, CA (US); Xiaolong Huang, San Jose, CA (US); Raja Banerjea, San Jose, CA (US); Ning Zhang, Saratoga, CA (US)

(21) Appl. No.: 15/875,878

(22) Filed: Jan. 19, 2018

(51) Int. Cl. H04W 72/08; H04W 72/04; H04L 5/00

(52) U.S. Cl. CPC H04W 72/085; H04L 69/22; H04L 5/0007; H04W 72/044

(57) ABSTRACT

This disclosure provides systems, devices, apparatus and methods, including computer programs encoded on storage media, for the scheduling of wireless resources to multiple wireless stations participating in a simultaneous transmission. Some implementations more specifically relate to the allocation of resource units (RUs) to stations for an uplink multi-user OFDMA (UL MU-OFDMA) transmission. In some implementations, an access point (AP) may adjust a modulation and coding scheme (MCS) of one of the stations based on the results of a power imbalance check. For example, in response to determining that a station failed the power imbalance check, the AP may reduce the MCS assigned to the station from a current value to a reduced value as opposed to simply dropping the station from the scheduled transmission. In some implementations, the AP then performs another power imbalance check based on the reduced MCS. The process may be repeated in an effort to provide all of the grouped stations the opportunity to successfully participate in the UL MU-OFDMA transmission.

### TECHNICAL FIELD

This disclosure relates generally to wireless communications, and more specifically, to the efficient scheduling of wireless resources to multiple wireless devices participating in a simultaneous transmission.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. As a result of the increasing ubiquity of wireless networks, many STAs may be associated with a given AP at any given time. For example, tens or hundreds of STAs may be served by a single AP in some high-density deployments. As technology has improved, so too have protocols for scheduling uplink traffic simultaneously from multiple STAs.

Some APs are configured to schedule multiple STAs to participate in a simultaneous uplink transmission and to determine transmission parameters for each of the STAs to use based on their associated payload sizes and power characteristics. Such APs are further configured to allocate resources to the STAs based on the transmission parameters. The STAs are then subject to a power imbalance check in an attempt to ensure the success of the transmission. In typical deployment scenarios, if one of the STAs fails the power imbalance check, the AP will remove that STA from the group participating in the transmission. The AP may subsequently perform additional power imbalance checks, each time dropping the lowest power station that failed the respective power imbalance check. After all the remaining stations pass the power imbalance check, the AP may then trigger the transmission. But this is inefficient, because the resources previously allocated to the removed STAs are wasted. To increase the efficiency, some APs may use the tones in the RUs previously allocated to the removed, failed stations to increase the sizes of the RUs allocated to one or more other participating stations. But such reallocation results in a drop in the per-tone signal to noise ratio (SNR) and the power spectral density (PSD), which may result in an unacceptable decrease in the power aggregation gain as well as an unacceptable increase in the access delay for the removed STAs.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes: identifying a number of wireless devices to participate in an uplink multi-user orthogonal frequency division multiple access (UL MU-OFDMA) transmission; determining a modulation and coding scheme (MCS) for each of the wireless devices to use for the UL MU-OFDMA transmission; allocating a resource unit (RU) for the UL MU-OFDMA transmission to each of the wireless devices based on the associated MCS; performing a receive power imbalance check for each of the wireless devices based on the allocation of the RUs and the MCS associated with the respective wireless device; responsive to determining that a first wireless device of the wireless devices failed the power imbalance check, reducing the MCS associated with the first wireless device; determining whether to initiate the UL MU-OFDMA transmission based on the reduced MCS; and triggering the UL MU-OFDMA transmission based on the determination.

Another innovative aspect of the subject matter described in this disclosure can be implemented in wireless communication device. In some implementations, the wireless communication device includes at least one antenna, a processor, and a memory communicatively coupled with the processor and storing processor-readable code that, when executed by the processor, causes the wireless communications device to perform operations. The operations include: identifying a number of wireless devices to participate in an uplink multi-user orthogonal frequency division multiple access (UL MU-OFDMA) transmission; determining a modulation and coding scheme (MCS) for each of the wireless devices to use for the UL MU-OFDMA transmission; allocating a resource unit (RU) for the UL MU-OFDMA transmission to each of the wireless devices based on the associated MCS; performing a receive power imbalance check for each of the wireless devices based on the allocation of the RUs and the MCS associated with the respective wireless device; responsive to determining that a first wireless device of the wireless devices failed the power imbalance check, reducing the MCS associated with the first wireless device; determining whether to initiate the UL MU-OFDMA transmission based on the reduced MCS; and triggering the UL MU-OFDMA transmission based on the determination.

Another innovative aspect of the subject matter described in this disclosure can be implemented in a tangible computer-readable storage medium comprising non-transitory processor-executable code operable to: identify a number of wireless devices to participate in an uplink multi-user orthogonal frequency division multiple access (UL MU-OFDMA) transmission; determine a modulation and coding scheme (MCS) for each of the wireless devices to use for the UL MU-OFDMA transmission; allocate a resource unit (RU) for the UL MU-OFDMA transmission to each of the wireless devices based on the associated MCS; perform a receive power imbalance check for each of the wireless devices based on the allocation of the RUs and the MCS associated with the respective wireless device; responsive to determining that a first wireless device of the wireless devices failed the power imbalance check, reduce the MCS associated with the first wireless device; determine whether to initiate the UL MU-OFDMA transmission based on the reduced MCS; and trigger the UL MU-OFDMA transmission based on the determination.

Some implementations of the methods, wireless devices and computer-readable storage media described herein further include steps, modules or code to determine a payload size associated with each of the wireless devices and determine a receive power value associated with each of the wireless devices. In some such implementations, the determination of the MCS for each of the wireless devices is based on the payload size and the receive power value, and wherein the allocation of the RUs to each of the wireless devices is further based on the payload size.

In some implementations of the methods, wireless devices and computer-readable storage media described herein, the determination of whether to initiate the uplink OFDMA transmission based on the reduced MCS includes performing a second power imbalance check for each of the wireless devices based on the reduced MCS. In some such implementations, the methods, wireless devices and computer-readable storage media described herein further include steps, modules or code to, responsive to determining that the first wireless device failed the second power imbalance check, determine whether the reduced MCS is a lowest MCS. In some such implementations, responsive to determining that the reduced MCS is not the lowest MCS, the MCS associated with the first wireless device is further reduced and it is then determined whether to initiate the UL MU-OFDMA transmission based on the further-reduced MCS. In some such implementations, responsive to determining that the reduced MCS is the lowest MCS, the first wireless device is removed from the number of wireless devices to participate in the UL MU-OFDMA transmission.

In some implementations, the methods, wireless devices and computer-readable storage media described herein further include steps, modules or code to, responsive to removing the first wireless device, increase a size of an RU allocated to a selected second wireless device of the wireless devices participating in the UL MU-OFDMA transmission using tones from the RU previously allocated to the first wireless device. Additionally or alternatively, in some implementations, the methods, wireless devices and computer-readable storage media described herein further include steps, modules or code to, responsive to removing the first wireless device, identify one or more other wireless devices not currently participating in the UL MU-OFDMA transmission and allocate an RU to a selected second wireless device of the other wireless devices using tones in the RU previously allocated to the first wireless device. In some such implementations, the second wireless device is selected based on a received signal strength indication (RSSI). In some implementations, the methods, wireless devices and computer-readable storage media described herein further include steps, modules or code to, determine a measure of a bandwidth efficiency of the UL MU-OFDMA transmission; determine whether to initiate the UL MU-OFDMA transmission based on the determined bandwidth efficiency; and trigger the UL MU-OFDMA transmission based on the determination.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication system.

FIG. 2A shows an example frame usable for communications between an access point (AP) and each of a number of stations (STAs) identified by the AP.

FIG. 2B shows another example frame usable for communications between an AP and each of a number of stations identified by the AP.

FIG. 3 shows a block diagram of an example AP for use in wireless communication.

FIG. 4 shows a block diagram of an example STA for use in wireless communication.

FIG. 5 shows a block diagram of an example AP for use in wireless communication according to some implementations.

FIG. 6 shows a flowchart illustrating an example process for scheduling an uplink multi-user orthogonal frequency division multiple access (UL MU-OFDMA) transmission according to some implementations.

FIG. 7 shows a flowchart illustrating an example process for determining whether to initiate an UL MU-OFDMA transmission according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to any of the Institute of Electrical and Electronics Engineers (IEEE) 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), orthogonal frequency division multiple access (OFDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Various implementations relate generally to the efficient scheduling of wireless resources to multiple wireless client devices (for example, stations) participating in a simultaneous transmission. Some implementations more specifically relate to the allocation of resource units (RUs) to stations for an uplink multi-user OFDMA (UL MU-OFDMA) transmission. In some implementations, an AP may adjust a modulation and coding scheme (MCS) of one of the stations based on the results of a power imbalance check. For example, in response to determining that a station failed the power imbalance check, the AP may reduce the MCS assigned to the station from a current value to a reduced value as opposed to simply dropping the station from the scheduled transmission. In some implementations, the AP then performs another power imbalance check based on the reduced MCS. The process may be repeated in an effort to provide all of the grouped stations the opportunity to successfully participate in the UL MU-OFDMA transmission. In some implementations, if a station fails a power imbalance check even after its MCS has been reduced to the lowest possible value, the AP will remove the station from the group of stations participating in the UL MU-OFDMA transmission. In some such implementations, the AP may recycle the RUs previously allocated to the removed station to increase the size of one or more RUs allocated to other stations in the group. Additionally or alternatively, the RUs previously allocated to the removed station may be reallocated to one or more additional stations newly added to the group by the AP.

Particular implementations of the subject matter described in this disclosure can be implemented to realize one or more of the following potential advantages. In some implementations, the described techniques can be used to eliminate or reduce reductions in the number of stations scheduled per PLCP protocol data unit (PPDU) transmission, and hand and hand, reduce reductions in power aggregation gain typically experienced when an UL MU-OFDMA grouping algorithm removes stations aggressively under high power imbalance conditions. Various implementations of an enhanced UL MU-OFDMA grouping algorithm as described herein can maintain high power aggregation gain and low access delay under varying high tolerance loss (TL) conditions. Some implementations also enable a reduction in a number of power imbalance check iterations required to schedule an UL MU-OFDMA transmission, which in turn reduces the number of UL MU-OFDMA RU allocation runs.

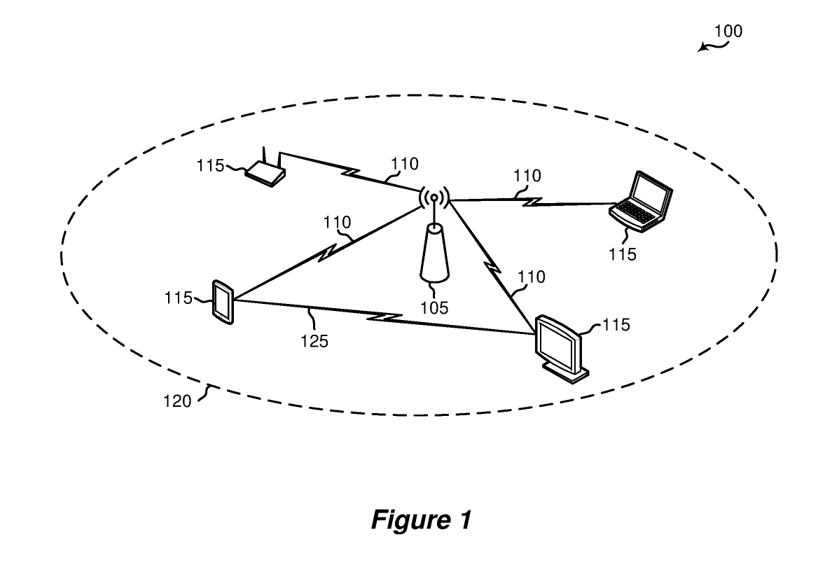

FIG. 1 shows a block diagram of an example wireless communication system 100. According to some aspects, the wireless communication system 100 can be an example of a wireless local area network (WLAN) (and will hereinafter be referred to as WLAN 100). For example, the WLAN 100 can be a network implementing at least one of the IEEE 802.11 family of standards. The WLAN 100 may include numerous wireless devices such as an access point (AP) 105 and multiple associated stations (STAs) 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN network 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the wireless devices described herein also may communicate in other frequency bands, such as the emerging 6 GHz band, which may support both licensed and unlicensed communications. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (e.g., AP 105) to shape and/or steer an overall antenna beam in the direction of a target receiver (e.g., a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (e.g., or antenna port) such that the desired beamforming effects are achieved. In some cases, these weights may be determined before beamforming can be employed. For example, the transmitter (e.g., the AP 105) may transmit one or more sounding packets to the receiver in order to determine CSI.

WLAN 100 may further support multiple-input, multiple-output (MIMO) wireless systems. Such systems may use a transmission scheme between a transmitter (e.g., AP 105) and a receiver (e.g., a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (e.g., each transmission may be beamformed differently). The receiver (e.g., STA 115) may try multiple beams (e.g., antenna subarrays) while receiving the signals.

WLAN protocol data units (PDUs) may be transmitted over a radio frequency spectrum band, which in some examples may include multiple sub-bands or frequency channels. In some cases, the radio frequency spectrum band may have a bandwidth of 80 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy LTF (L-LTF) information, and legacy signaling (L-SIG) information. The legacy preamble may be used for packet detection, automatic gain control and channel estimation, among other uses. The legacy preamble may also be used to maintain compatibility with legacy devices.

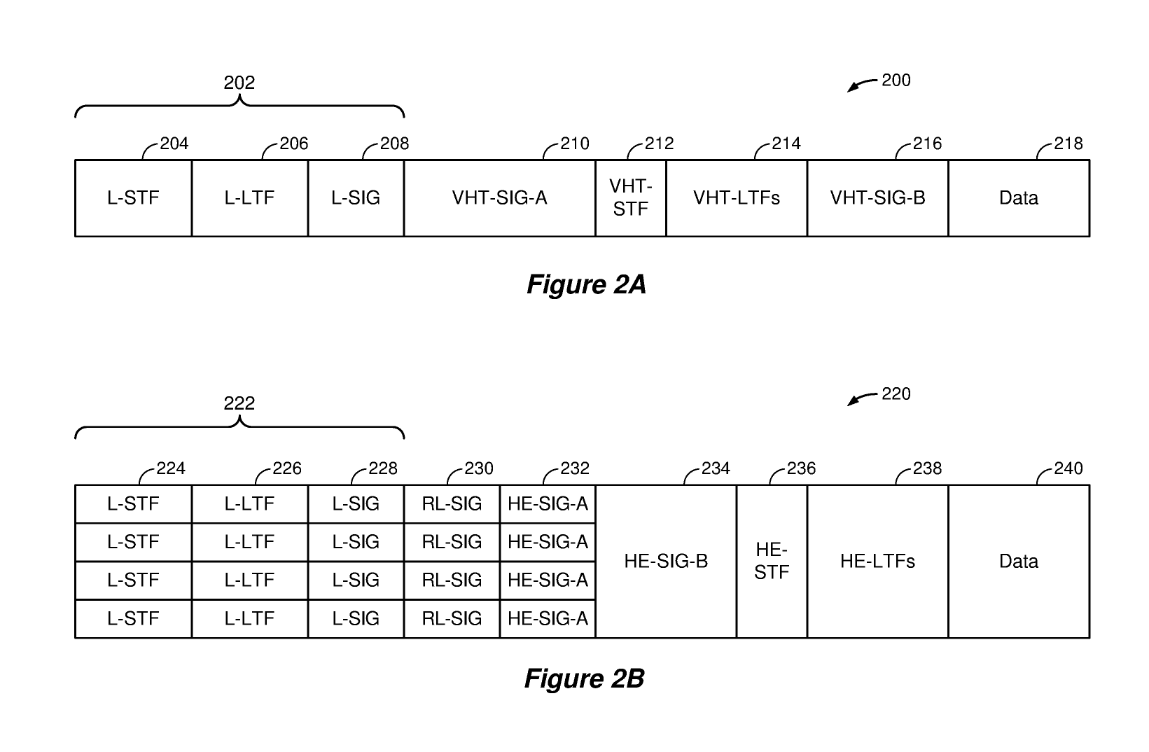

FIG. 2A shows an example frame 200 usable for communications between an AP and each of a number of stations identified by the AP. For example, the frame 200 can be formatted as a very high throughput (VHT) frame in accordance with the IEEE 802.11ac amendment to the IEEE 802.11 set of standards. The frame 200 includes a legacy preamble portion 202 that includes a legacy short training field (L-STF) 204, a legacy long training field (L-LTF) 206, and a legacy signaling field (L-SIG) 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216. The frame 200 also can include a payload or data portion 218 after the preamble. The data portion 218 can include medium access control (MAC) protocol data units (MPDUs), for example, in the form of an aggregated MPDU (AMPDU).

The frame 200 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 204, 206 and 208, respectively, may be duplicated and transmitted in each of the plurality of sub-bands. The information in the VHT-SIG-A field 210 is also duplicated and transmitted in each sub-band.

The VHT-SIG-A field 210 may indicate to a station that the frame 200 is an IEEE 802.11ac frame. The VHT-SIG-A field 210 also may include VHT WLAN signaling information usable by stations other than the number of stations that are identified to receive downlink communications in the frame 200. The VHT-SIG-A field 210 also includes information usable by the identified number of stations to decode the VHT-SIG-B field 216. The VHT-SIG-B field 216 may include VHT WLAN signaling information usable by the number of stations identified to receive downlink communications in the frame 200. More specifically, the VHT-SIG-B field 216 may include information usable by the number of stations to decode data received in the data portion 218. The VHT-SIG-B field 216 may be encoded separately from the VHT-SIG-A field 210. The number of VHT-LTFs 214 depends on the number of transmitted streams.

FIG. 2B shows another example frame 220 usable for communications between an AP and each of a number of stations identified by the AP. For example, the frame 220 can be formatted as a high efficiency (HE) frame in accordance with the IEEE 802.11ax amendment to the IEEE 802.11 set of standards. The frame 220 includes a legacy preamble portion 222 that includes a legacy short training field (L-STF) 224, a legacy long training field (L-LTF) 226, and a legacy signaling field (L-SIG) 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234, a high efficiency short training field (HE-STF) 236 and a number of high efficiency long training fields (HE-LTFs) 238. The frame 220 also can include a payload or data portion 240 after the preamble. The data portion 240 can include medium access control (MAC) protocol data units (MPDUs), for example, in the form of an aggregated MPDU (AMPDU).

The frame 220 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 224, 226 and 228, respectively, may be duplicated and transmitted in each of the plurality of sub-bands. The information in the RL-SIG field 230 and the HE-SIG-A field 232 is also duplicated and transmitted in each sub-band as shown in FIG. 2B.

The RL-SIG field 230 may indicate to a station that the frame 220 is an IEEE 802.11ax frame. The HE-SIG-A field 232 may include high efficiency WLAN signaling information usable by stations other than the number of stations that are identified to receive downlink communications in the frame 220. The HE-SIG-A field 232 may also include information usable by the identified number of stations to decode the HE-SIG-B field 234. The HE-SIG-B field 234 may include high efficiency WLAN signaling information usable by the number of stations identified to receive downlink communications in the frame 220. More specifically, the HE-SIG-B field 234 may include information usable by the number of stations to decode data received in the data portion 240. The HE-SIG-B field 234 may be encoded separately from the HE-SIG-A field 232.

High efficiency (HE) WLAN (HEW) preambles can be used to schedule multiple devices, such as STAs 115, for multi-user simultaneous transmissions (for example, using multi-user orthogonal frequency division multiple access (MU-OFDMA) or multi-user multiple-input, multiple-output (MU-MIMO) techniques). A HEW signaling field may be used to signal a resource unit (RU) allocation pattern to multiple receiving STAs 115. The HEW signaling field can include a common user field that is decodable by multiple STAs 115, as well as a resource allocation field. The resource allocation field can indicate RU distributions to multiple STAs 115 and indicate which RUs in a resource unit distribution correspond to MU-MIMO transmissions and which RUs correspond to MU-OFDMA transmissions. The HEW signaling field also can include, subsequent to the common user field, dedicated station-specific signaling fields that are assigned to particular STAs 115 and used to schedule resources and to indicate the scheduling to other WLAN devices.

An AP may configure one or more trigger frames to initiate and synchronize uplink (UL) transmissions from the STAs, including UL MU-OFDMA and UL MU-MIMO transmissions. Such trigger frames may thus enable multiple STAs to send uplink traffic to an AP concurrently in time. A trigger frame may address one or more STAs through an association identification (AID) for each STA, and may assign each AID one or more unique RUs that can be used to send uplink traffic to the AP.

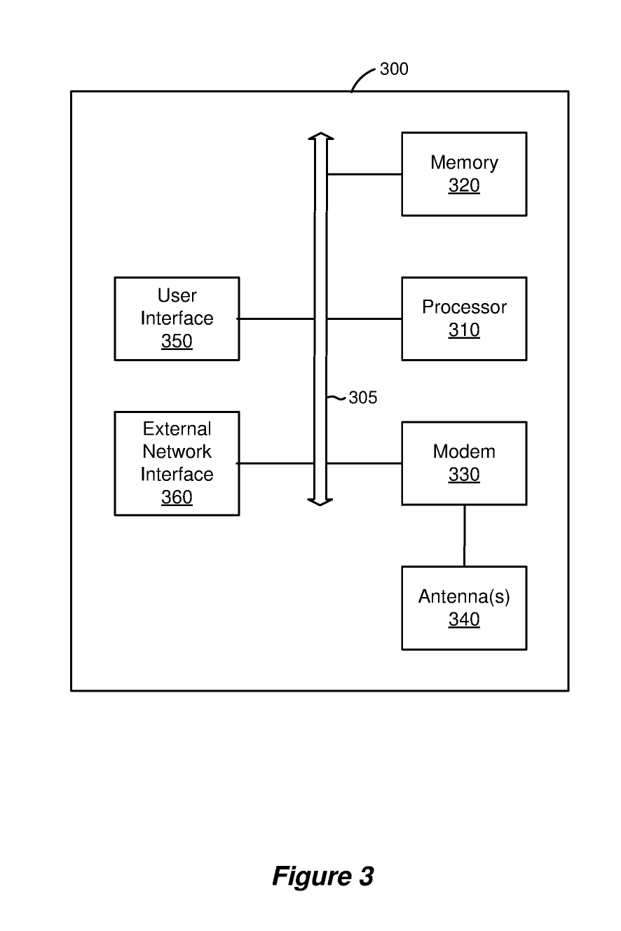

FIG. 3 shows a block diagram of an example access point (AP) 300 for use in wireless communication. For example, the AP 300 may be an example of aspects of the AP 105 described with reference to FIG. 1. The AP 300 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The AP 300 includes a processor 310, a memory 320, a modem 330, at least one antenna 340, a user interface (UI) 350, and an external network interface 360 (for example, to connect with a wired or wireless backhaul). Each of the components (or “modules”) described with reference to FIG. 3 can communicate with one another, directly or indirectly, over at least one bus 305.

The memory 320 can include random access memory (RAM) and read-only memory (ROM). The memory 320 also can store processor- or computer-executable software (SW) code containing instructions that, when executed by the processor 310, cause the processor to perform various functions described herein for wireless communication, including generation and transmission of a downlink frame and reception of an uplink frame.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the modem 330 and the external network interface 360. The processor 310 also can process information to be sent to the modem 330 for transmission through the antenna 340 and information to be sent to the external network interface 360. The processor 310 can generally be configured to perform various operations related to generating and transmitting a downlink frame and receiving an uplink frame.

The modem 330 is generally configured to modulate packets and to provide the modulated packets to the antenna 340 for transmission, as well as to demodulate packets received from the antenna 340 to provide demodulated packets. The modem 330 generally includes or is coupled with at least one radio frequency (RF) transmitter and at least one RF receiver, which may be combined into one or more transceivers. For example, the AP 300 can typically include multiple transceivers and antennas 340. For example, in some AP implementations, the AP 300 can include multiple transmit antennas (each with a corresponding transmit chain) and multiple receive antennas (each with a corresponding receive chain). The modem 330 can communicate bi-directionally, via the antenna 340, with at least one station 115 as, for example, shown in FIG. 1. The AP 300 may communicate with a core or backhaul network through the external network interface 360 to gain access to external networks including the Internet.

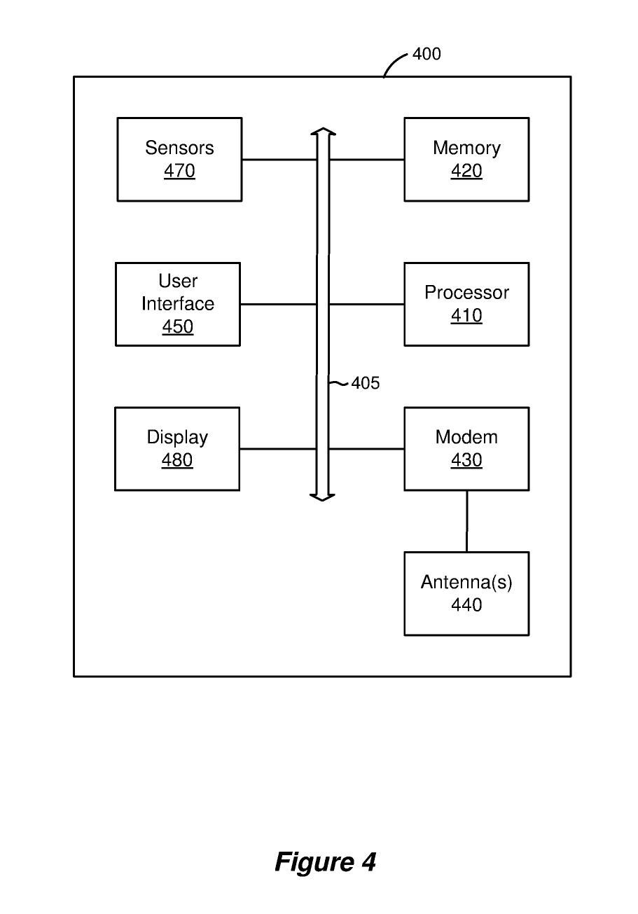

FIG. 4 shows a block diagram of an example wireless station (STA) 400 for use in wireless communication. For example, the STA 400 may be an example of aspects of the STA 115 described with reference to FIG. 1. The STA 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The STA 400 includes a processor 410, a memory 420, a modem 430 and at least one antenna 440. In some implementations, the STA 400 additionally includes some or all of the following: a user interface (UI) 450 (such as a touchscreen or keypad), one or more sensors 470 (such as one or more inertial sensors, accelerometers, temperature sensors, pressure sensors, or altitude sensors), and a display 480. Each of the components (or “modules”) described with reference to FIG. 4 can communicate with one another, directly or indirectly, over at least one bus 405.

The memory 420 can include RAM and ROM. The memory 420 also can store processor- or computer-executable SW code containing instructions that, when executed, cause the processor 410 to perform various functions described herein for wireless communication, including reception of a downlink frame and generation and transmission of an uplink frame.

The processor 410 includes an intelligent hardware device such as, for example, a CPU, a microcontroller, an ASIC or a PLD such as an FPGA, among other possibilities. The processor 410 processes information received through the transceiver 430 as well as information to be sent to the transceiver 430 for transmission through the antenna 440. The processor 410 can be configured to perform various operations related to receiving a downlink frame and generating and transmitting an uplink frame.

The modem 430 is generally configured to modulate packets and provide the modulated packets to the antenna 440 for transmission, as well as to demodulate packets received from the antenna 440 to provide demodulated packets. The modem 430 generally includes at least one radio frequency (RF) transmitter and at least one separate RF receiver, which may be combined into one or more transceivers. For example, in some implementations, the STA 400 can include multiple transmit antennas (each with a corresponding transmit chain) and multiple receive antennas (each with a corresponding receive chain). The modem 430 can communicate bi-directionally, via the antenna 440, with at least one AP 105, for example, shown in FIG. 1. As is described above, in some implementations, the modem also can communicate bi-directionally, via the antenna 440, with other STAs directly without the use of an intermediary AP.

Because the various wireless stations associated with an AP may experience different gains and losses, for example, because the stations may be at different distances from the AP, have different channel conditions or have different capabilities, the respective link budgets associated with the various stations may be significantly different. As such, the strength or power (Rx power) of the signals received from the various stations by the AP may differ proportionately. An AP's transceiver, and particularly the analog-to-digital converter (ADC), may not be able to tolerate wide differences in Rx power from different stations in an uplink OFDMA transmission. The higher power signals will consume a greater portion of the ADC's dynamic range, and thus, the ADC may not be sensitive to all transmissions. Compounding the problem are physical impairments in the respective channels (for example, phase noise or carrier frequency offset (CFO)) that reduce the effective dynamic range of the AP's ADC. The consequential reduction in the acceptable or tolerable difference or imbalance in Rx powers from the respective stations is referred to as tolerance loss. For example, assume that an AP can sense a relatively low power device at −30 dbm and sense a relatively high power device at −20 dbm, the AP will be able to accommodate both of the devices if it can tolerate a 10 dbm difference (power imbalance). But with physical impairments, the tolerable difference is reduced, and thus, the weaker station may fail.

When an AP determines to schedule an UL MU-OFDMA transmission, the AP identifies a group of stations to participate. The AP also determines a payload size and receive (Rx) power value for each of the identified stations. For example, the respective payload sizes may be determined from buffer status reports (BSRs) previously received from the stations indicating amounts of data in their respective buffers. Similarly, the Rx power values may be determined from measurements of previously received transmissions from the respective stations. The AP determines a modulation and coding scheme (MCS) for each of the identified stations based on their respective payload sizes and Rx power values. The AP then allocates resource units (RUs) to the stations based on their respective payload sizes and MCS values. Prior to transmission, the AP performs a power imbalance check for each of the stations based on the respective RU size and MCS value assigned to the station.

In typical deployment scenarios, if one of the stations fails the power imbalance check, the AP will remove that station from the group of wireless devices participating in the UL MU-OFDMA transmission. The AP may subsequently perform additional power imbalance checks, each time dropping the lowest power station that failed the respective power imbalance check, until no stations fail the check. After all stations pass the power imbalance check, the AP may then trigger the UL MU-OFDMA transmission (for example, by transmitting one or more trigger frames to the stations). But this is inefficient, because the tones in the RUs previously allocated to the removed, failed stations are not used, and thus, valuable resources are wasted. To increase the efficiency, some APs may use the tones in the RUs previously allocated to the removed, failed stations to increase the sizes of the RUs allocated to one or more other participating stations. But such reallocation results in a drop in the per-tone signal to noise ratio (SNR) and the power spectral density (PSD), which result in a decrease in the power aggregation gain. In other words, the respective throughput rates are not optimized, for example, because their associated MCSs may be increased. Additionally, if conditions persist, the removed users may be dropped from numerous UL MU-OFDMA transmissions, and as such, not be served sufficiently.

As described above, various implementations relate generally to the efficient scheduling of wireless resources to multiple wireless client devices (for example, stations) participating in a simultaneous transmission. Some implementations more specifically relate to the allocation of resource units (RUs) to stations for an uplink multi-user OFDMA (UL MU-OFDMA) transmission. In some implementations, an AP may adjust an MCS of one of the stations based on the results of a power imbalance check. For example, in response to determining that a station failed the power imbalance check, the AP may reduce the MCS assigned to the station from a current value to a reduced value as opposed to simply dropping the station from the scheduled transmission. In some implementations, the AP then performs another power imbalance check based on the reduced MCS. The process may be repeated in an effort to provide all of the grouped stations the opportunity to successfully participate in the UL MU-OFDMA transmission. In such a manner, various implementations eliminate or reduce the reductions in power aggregation gain typically experienced in conventional deployments. In some implementations, if a station fails a power imbalance check even after its MCS has been reduced to the lowest possible value, the AP will remove the station from the group of stations participating in the UL MU-OFDMA transmission. In some such implementations, the AP may recycle the RUs previously allocated to the removed station to increase the size of one or more RUs allocated to other stations in the group. Additionally or alternatively, the RUs previously allocated to the removed station may be reallocated to one or more additional stations newly added to the group by the AP.

Particular implementations of the subject matter described in this disclosure can be implemented to realize one or more of the following potential advantages. In some implementations, the described techniques can be used to eliminate or reduce reductions in the number of stations scheduled per PLCP protocol data unit (PPDU) transmission, and hand and hand, reduce reductions in power aggregation gain typically experienced when an UL MU-OFDMA grouping algorithm removes stations aggressively under high power imbalance conditions. Various implementations of an enhanced UL MU-OFDMA grouping algorithm as described herein can maintain high power aggregation gain and low access delay under varying high tolerance loss (TL) conditions. Some implementations also enable a reduction in a number of power imbalance check iterations required to schedule an UL MU-OFDMA transmission, which in turn reduces the number of UL MU-OFDMA RU allocation runs.

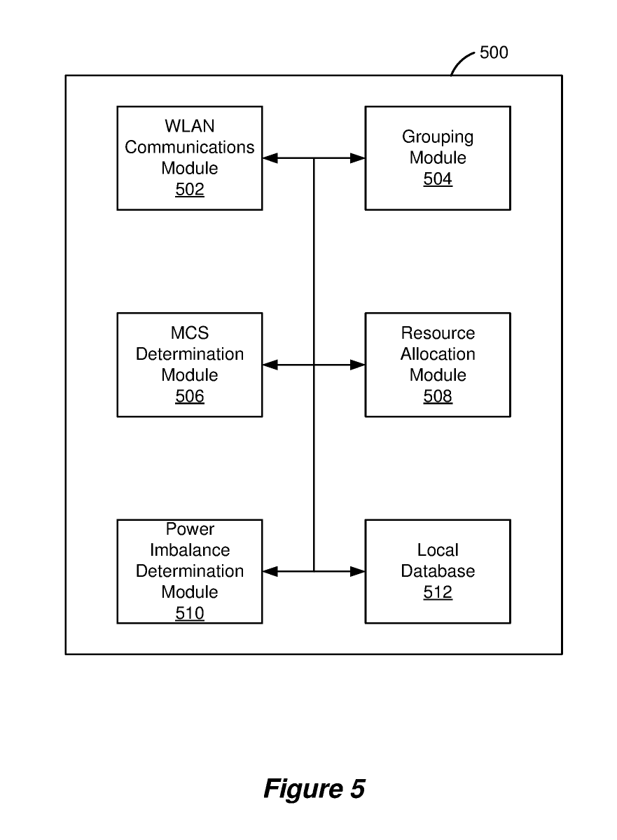

FIG. 5 shows a block diagram of an example AP 500 for use in wireless communication according to some implementations. In some implementations, the AP 500 can be an example of the APs 105 and 300 described above with reference to FIGS. 1 and 3, respectively. In some other implementations, the AP 500 may be an example of a software-enabled access point (SoftAP) such as a STA (for example, such as the STA 400 described above with reference to FIG. 4). The AP 500 includes a WLAN communications module 502, a grouping module 504, an MCS determination module 506, a resource allocation module 508, a power imbalance determination module 510 and a local database 512. In some implementations, each of the modules 502, 504, 506, 508 and 510 are implemented as software or firmware stored in a memory (such as the memory 320). For example, each of the modules 502, 504, 506, 508 and 510 can be implemented as non-transitory instructions (or “code”) executable by a processor (such as the processor 310).

The local database 512 may be stored with each of the modules 502, 504, 506, 508 and 510 in a memory (such as the memory 320). In some other implementations, the local database 512 is stored in or implemented by another memory or memory device logically or physically separate from the memory used to store each of the modules 502, 504, 506, 508 and 510. In various implementations, the local database 512 stores profile information for various other wireless devices. The local database 512 can store profile information for each station it is or has been associated with, as well as profile information for one or more stations it has not previously associated with. For example, the profile information may include any of the scanning information obtained through passive or active scans as well as any information received in any probe requests or in conjunction with any association requests. The profile information can include, for each wireless device, a respective SSID, a respective MAC address, a respective IP address, a number of capabilities or capability requirements, supported data rates, one or more parameters associated with the respective wireless network, a connection history with the AP, a geographic location of the wireless device, channel state information (CSI), RSSI values, or any other suitable information.

In some implementations, the processor can execute the WLAN communications module 502 to manage communications based on an Institute of Electrical and Electronics Engineers (IEEE) 802.11 standard specification such as the 802.11-2016 standard as well as current and future amendments thereof, including 802.11ax. For example, the WLAN communication module 502 is configured to generate, exchange and process frames (such as data frames, control frames, management frames, and trigger frames) to be transmitted to, or received from, one or more wireless devices (for example, stations such as the STA 400 described above with reference to FIG. 4) via a modem (such as modem 430). The WLAN communication module 502 also can be configured to perform passive or active scan operations on one or more frequency bands (for example, the 2.4 GHz, 5 GHz, 6 GHz or 60 GHz bands). The WLAN communication module 504 also is configured to manage association, authentication and security with various wireless devices seeking network access via the AP.

The processor can execute the grouping module 504 to group (or “schedule”) wireless devices for MU-MIMO and MU-OFDMA transmissions. For example, the grouping module 504 can identify a number of wireless devices to participate in an UL MU-OFDMA transmission based on the IEEE 802.11ax protocol. In some implementations, the grouping module 504 is configured to identify or otherwise determine a payload size associated with a payload to be transmitted from each of the wireless devices participating in the UL MU-OFDMA transmission. For example, the grouping module 504 can determine the payload size of a particular wireless device from a buffer status report (BSR) transmitted from the wireless device in response to a buffer status poll, or by any other suitable means. In some implementations, the grouping module 504 also is configured to identify or otherwise determine a receive power associated with the wireless signals to be transmitted from each of the wireless devices during the UL MU-OFDMA transmission. For example, the grouping module 504 can determine the Rx power associated with a particular wireless device based on a measured Rx received signal strength indication (RSSI), or by any other suitable means.

The processor can execute the MCS determination module 506 to determine an initial MCS for the wireless signals to be transmitted from each of the wireless devices during the UL MU-OFDMA transmission. In some implementations, the MCS determination module 506 determines an initial MCS for each of the wireless devices based on the respective payload size and the Rx power determined by the grouping module 504. As an example for an IEEE 802.11ax UL MU-OFDMA transmission, the MCS determination module 506 can select an initial MCS between MCS0 (using BPSK and corresponding to the lowest data rate) and MCS11 (using 1024-QAM and corresponding to the highest data rate).

The processor can execute the resource allocation module 508 to allocate one or more RUs to each of the wireless devices to use during the UL MU-OFDMA transmission. The allocation of the one or more RUs to each of the participating wireless devices includes the assignment of each RU to the respective wireless device and the definition of the RU's size. For example, in IEEE 802.11ax, the size of an RU is quantized in terms of the number of data subcarriers (or “tones”); the possible RU sizes are 26, 52, 106, 242, 484 and 996 tones. The resource allocation module 508 determines the allocation (including the assignments and sizes) of the RUs to the participating wireless devices based on the respective initial MCS values and the respective payload sizes.

In some implementations, the resource allocation module 508 selects as the initial MCS the smallest MCS that will enable the respective wireless device to serve its payload in the allotted transmission time. In some such implementations, the resource allocation module 508 starts the initial MCS determination process for each device with the assumption that the wireless device will use the minimum RU size. The resource allocation module 508 then calculates or otherwise determines an estimated per-tone SNR for the wireless device based on the assumed RU size and its recent link budget (for example, the per-tone SNR can be determined from the quotient of the Rx RSSI over the RU size). The resource allocation module 508 then calculates or otherwise determines an MCS value based on the estimated SNR (for example, based on a sensitivity determined based on the estimated SNR). The resource allocation module 508 may then use the determined MCS as the initial MCS if the required RU size (based on the respective payload) is equal to the assumed RU size. Otherwise, if the required RU size is larger than the assumed RU size, the size of the assumed RU is incremented by the minimum RU size and the process repeats. More specifically, the resource allocation module 508 would then calculate a new estimated SNR for the wireless device based on the RU size and link budget, calculate a new MCS based on the new SNR, and again compare the required RU size with the assumed RU size to determine whether to use the new MCS as the initial MCS or to again increment the assumed RU size and repeat the process.

In some implementations, the resource allocation module 508 caps the RU size for each of the participating wireless devices by a function. For example, the function can be a ceiling function such as ceiling

$$( \frac{BW}{n} \cdot α ) ,$$

where BW represents the bandwidth of the UL OFDMA Rx bandwidth, n represents the number of users (wireless devices), and α≥21.5. This ensures that each wireless device will be able to utilize the power spectral density (PSD) boost gained as a result of reducing the UL Tx bandwidth of each individual user. Thus, the resource allocation module 508 determines the minimum RU size each wireless device should use to serve its payload with PSD boost.

The processor can execute the power imbalance determination module 510 to perform an Rx power imbalance check for each of the wireless devices based on the allocation of RUs and the MCS associated with the respective wireless device. In some implementations, performing the Rx power imbalance check includes determining whether, for each user i (each wireless device participating in the UL MU-OFDMA transmission), the following inequality (1) holds true.

R_{ADC}^{dB}−10 log 10(1+Σ_{i≠k}10^{01*ΔRSSI}^{ᵢₖ}^{^{dB}})+10 log 10(Nᵣₓ)≥RSSIₖ^{sens}+TLₖ^{imp}+αΔPₖ (1)

In inequality (1), each other user k represents another of the participating wireless devices being compared with user i; R_{AC} represents the dynamic range of the AP's analog-to-digital converter (ADC); ΔRSSIₖ^{dB}=RSSIᵢ^{dB}−RSSIₖ^{dB} and represents the per-tone power difference in decibels (dBs) between user i and user k; Nᵣₓ represents the number of Rx chains of user k; RSSIₖ^{sens} represents the SU sensitivity of the AP with user k's MCS; TLₖ^{imp} represents the total power imbalance tolerance loss due to system impairments; ΔPₖ (an optional term) represents the power difference between user k and its neighboring users less their transmitter error vector magnitude (TxEVM) requirement difference; and β is a value in the range of 0 and 1 (which may be determined from simulation). As such, performing the Rx power imbalance check includes comparing each user with all other users based on their RU allocations and MCS values.

In some implementations, the power imbalance determination module 510 is configured to, if a wireless device fails the power imbalance check, signal the failure to the MCS determination module 506. The MCS determination module 506 is configured to adjust the MCS of the failed wireless device based on the results of the power imbalance check. In some more specific implementations, in response to determining that the wireless associated with the lowest Rx power failed the power imbalance check, the MCS determination module 506 may reduce the MCS assigned to the wireless device. For example, the MCS determination module 506 may reduce the MCS associated with the lowest power wireless device by one level (for example, from MCS4 to MCS3).

In some implementations, the power imbalance determination module 510 then determines whether to initiate the UL MU-OFDMA transmission based on the reduced MCS. In some such implementations, to make the determination, the power imbalance determination module 510 performs another Rx power imbalance check based on the reduced MCS. The process of reducing the MCS associated with the lowest power wireless device and the subsequent performance of an additional Rx power imbalance check may be repeated in an effort to provide all of the grouped wireless devices the opportunity to successfully participate in the UL MU-OFDMA transmission. In some such implementations, if the lowest power wireless device fails a Rx power imbalance check even after its associated MCS has been reduced to the lowest possible value (for example, MS0), the power imbalance determination module 510 signals the grouping module 504, which removes the wireless device from the group of wireless devices participating in the UL MU-OFDMA transmission.

In some implementations, after the lowest power wireless device has been removed, the power imbalance determination module 510 then performs another Rx power imbalance check on the remaining wireless devices in the group. If a wireless device (for example, the new lowest power wireless device) fails the Rx power imbalance check, the process repeats as described above with the MCS determination module 506 reducing the MCS associated with the new lowest power wireless device followed by the power imbalance determination module 510 performing a subsequent Rx power imbalance check based on the reduced MCS.

In some implementations, after all of the wireless devices remaining in the group have passed the power imbalance check, the power imbalance determination module 510 signals the WLAN communications module 502 to trigger the UL MU-OFDMA transmission from the remaining devices. For example, the WLAN communications module 502 can generate and transmit one or more unicast, multicast or broadcast trigger frames to the wireless devices to trigger the wireless devices to transmit their respective UL OFDMA transmissions.

In some implementations, before the power imbalance determination module 510 signals the WLAN communications module 502 to trigger the UL MU-OFDMA transmission, it first attempts to use (or “recycle”) the RUs previously allocated to the removed wireless device(s). For example, the power imbalance determination module 510 may signal the resource allocation module 508, which may then increase the sizes of one or more RUs allocated to other ones of the wireless devices remaining in the group. Additionally or alternatively, the resource allocation module 508 may signal the grouping module 504, which may then identify one or more wireless devices not currently in the group and add them to the group. The resource allocation module 508 may then allocate some or all of the RUs previously allocated to the removed wireless devices to the one or more newly added wireless devices.

In some implementations, the resource allocation module 508 then signals the WLAN communications module 502 trigger the UL MU-OFDMA transmission. In some other implementations, before the resource allocation module 508 signals the WLAN communications module 502 to trigger the UL MU-OFDMA transmission, it first determines a value representative of a bandwidth efficiency of the to-be-triggered UL MU-OFDMA transmission. For example, the bandwidth efficiency value can be proportional to the ratio of the bandwidth allocated to the participating wireless devices to the total aggregated bandwidth. In some such implementations, the resource allocation module 508 compares the bandwidth efficiency value to a threshold and signals the WLAN communications module 502 to trigger the UL MU-OFDMA transmission based on the comparison. For example, if the bandwidth efficiency value is greater than the threshold, the resource allocation module 508 signals the WLAN communications module 502 to trigger the UL MU-OFDMA transmission. In some implementations, if the bandwidth efficiency value is less than the threshold, the resource allocation module 508 signals the grouping module 504 that the scheduled UL MU-OFDMA transmission is not to occur. In some such implementations, the grouping module 504 then attempts to schedule users for a new UL MU-OFDMA transmission.

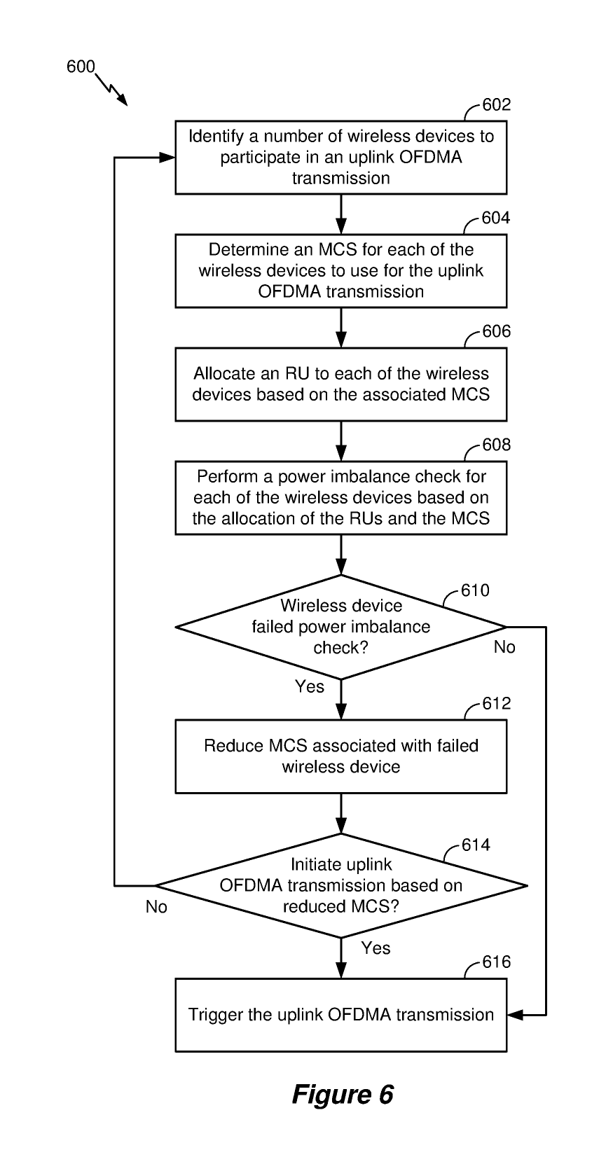

FIG. 6 shows a flowchart illustrating an example process 600 for scheduling an UL MU-OFDMA transmission according to some implementations. In some implementations, the UL MU-OFDMA transmission is to be transmitted in one or more of the 2.4 GHz band, the 5 GHz band, the 6 GHz band or the 60 GHz band. In some implementations, the process 600 is performed by a wireless access point such as the AP 500 described above with reference to FIG. 5.

In some implementations, the process 600 begins in block 602 with identifying a number of wireless devices to participate in the UL MU-OFDMA transmission. In some such implementations, the process 600 further includes determining a payload size associated with a payload to be transmitted from each of the wireless devices participating in the UL MU-OFDMA transmission. An Rx power associated with the wireless signals to be transmitted from each of the participated wireless devices may also be determined. In some such implementations, the identification (in block 602) of the wireless devices may be based on the respective payload sizes and Rx powers.

In block 604, the process 600 continues with determining an initial MCS for each of the participating wireless devices to use for the UL MU-OFDMA transmission. For example, in some implementations, the determination (in block 604) of the initial MCSs for each of the wireless devices is based on the respective payload sizes and Rx powers. In some implementations, the initial MCS represents the smallest MCS that will enable the respective wireless device to serve its payload in the allotted transmission time, and in some such implementations, with the desired PSD boost. In some implementations, the process 600 proceeds in block 606 with allocating one or more RUs to each of the wireless devices to use during the UL MU-OFDMA transmission. For example, the allocation (in block 606) of the RUs to the participating wireless devices can be based on the respective initial MCS values and the respective payload sizes.

In block 608, the process 600 continues with performing an Rx power imbalance check for each of the wireless devices based on the allocation of RUs and the MCSs associated with the respective wireless devices. For example, performing the Rx power imbalance check can include determining whether, for each user i (each wireless device participating in the UL MU-OFDMA transmission), the inequality (1) above holds true. As such, performing the Rx power imbalance check may include comparing each user with all other users based on their RU allocations and MCS values.

In some implementations, the process 600 proceeds with determining, in block 610, whether any of the participating wireless devices failed the power imbalance check performed in block 608. If no devices failed the power imbalance check, then the process 600 may proceed in block 616 with triggering the UL MU-OFDMA transmission. However, if at least one of the wireless devices fails the power imbalance check, the process 600 proceeds in block 612 with reducing the MCS associated with the failed wireless device having the lowest Rx power. For example, the MCS associated with the lowest Rx power wireless device may be reduced by one level (for example, from MCS4 to MCS3). In some other implementations or instances, the MCS may be reduced by more than one level, for example, by two or more levels or generally to a level that is estimated to result in passage of a subsequent power imbalance check.

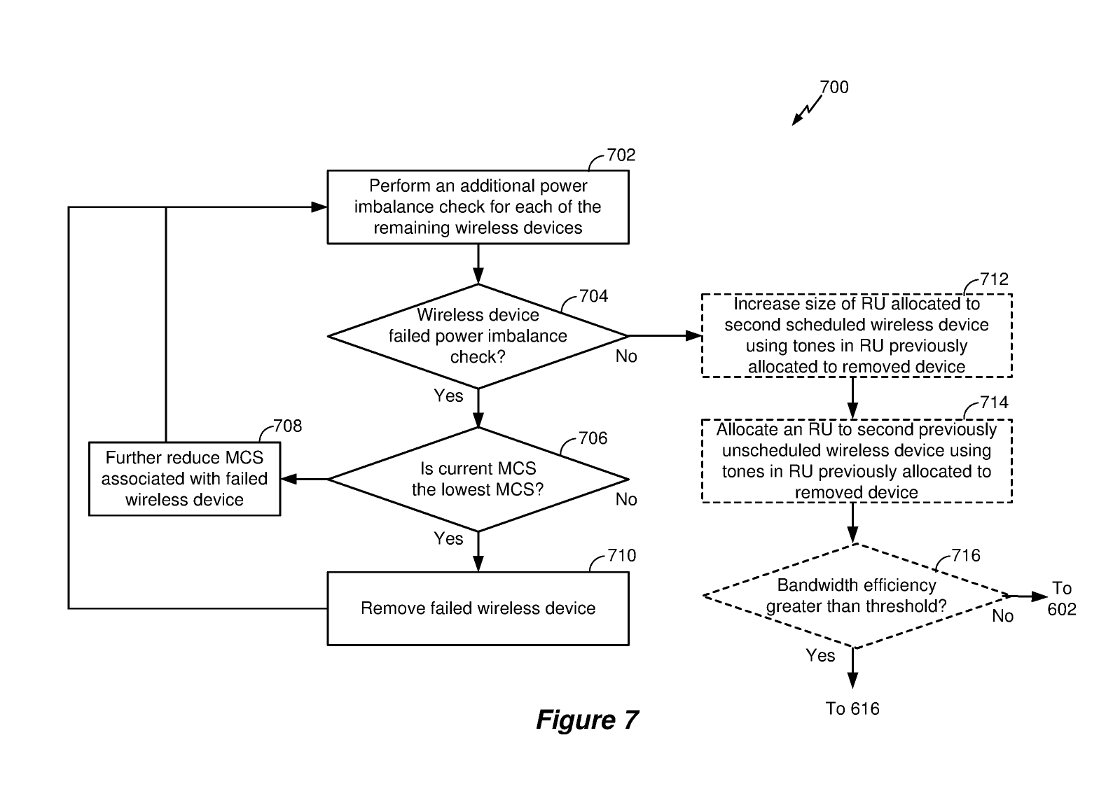

After reducing the MCS, the process 600 proceeds with determining, in block 614, whether to initiate the UL MU-OFDMA transmission based on the reduced MCS. In some implementations, the determination (in block 614) of whether to initiate the UL MU-OFDMA transmission based on the reduced MCS includes a number of sub-blocks. FIG. 7 shows a flowchart illustrating an example process 700 for determining whether to initiate an UL MU-OFDMA transmission according to some implementations. For example, the determination in block 614 can include the performance of the process 700. In some implementations, the process 700 begins in block 702 with performing an additional Rx power imbalance check for each of the current set of wireless devices based on the reduced MCS. In some implementations, the process 700 proceeds with determining, in block 704, whether any of the participating wireless devices failed the power imbalance check performed in block 702.

If at least one of the wireless devices fails the additional power imbalance check, the process 700 proceeds in block 706 with determining whether the current MCS associated with the lowest power wireless device is the lowest MCS. If it is determined that the current MCS is not the lowest MCS, the process 700 proceeds in block 708 with further reducing the MCS associated with the lowest power device. The process 700 then proceeds back to block 702 for the performance of another Rx power imbalance check based on the further reduced MCS. If it is determined in block 706 that the current MCS is the lowest MCS, the process 700 continues in block 710 with removing the failed lowest power wireless device from the group of wireless devices scheduled to participate in the UL MU-OFDMA transmission. The process 700 then proceeds back to block 702 for the performance of another Rx power imbalance check based on the remaining wireless devices.

In some implementations, if it is determined in block 704 that there are not any remaining devices that fail the power imbalance check, the process 700 may then end and the process 600 may resume and proceed to block 616 with triggering the UL MU-OFDMA transmission. In some other implementations, the process 700 may continue with the performance of one or more optional steps (such as optional blocks 712, 714 and 716 described below) to use or recycle the RUs previously allocated to the removed, failed wireless device(s). For example, in some such implementations, the process 700 may continue in block 712 with increasing the sizes of one or more RUs allocated to one or more other non-failed participating wireless devices remaining in the group. For example, an RU adjacent to an RU previously allocated to a removed wireless device may be increased in size using tones from the adjacent RU. For example, an RU of a second wireless device in the group may be increased from 26 to 52 tones using 26 tones formerly allocated to the removed wireless device. Additionally or alternatively, in some implementations, the process 700 may continue in block 714 with allocating one or more RUs to one or more other wireless devices not previously participating in the group. For example, a wireless device not previously participating in the current UL MU-OFDMA transmission may be identified based on its RSSI or some other suitable factors and allocated an RU using tones from the RU previously allocated to the removed, failed wireless device.

In some implementations, such as after the performance of one or both of blocks 712 and 714, the process 700 may continue in block 716 with determining a value representative of a bandwidth efficiency of the to-be-triggered UL MU-OFDMA transmission and determining whether to trigger the UL MU-OFDMA transmission based on the determined value. For example, the bandwidth efficiency value can be compared to a threshold to determine whether to trigger the UL MU-OFDMA transmission. In some such implementations, if the bandwidth efficiency value is below the threshold, the process 700 may end and the process 600 may resume and proceed back to block 602 with identifying a new group of particular wireless devices to participate in an upcoming UL MU-OFDMA transmission. In some implementations, if the bandwidth efficiency value is greater than the threshold, the process 700 may end and the process 600 may resume and proceed to block 616 with triggering the UL MU-OFDMA transmission.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication comprising:
identifying a number of wireless devices to participate in an uplink multi-user orthogonal frequency division multiple access (UL MU-OFDMA) transmission;
determining a modulation and coding scheme (MCS) for each of the wireless devices to use for the UL MU-OFDMA transmission;
allocating a resource unit (RU) for the UL MU-OFDMA transmission to each of the wireless devices based on the associated MCS;
performing a receive power imbalance check for each of the wireless devices based on the allocation of the RUs and the MCS associated with the respective wireless device;
responsive to determining that a first wireless device of the wireless devices failed the power imbalance check, reducing the MCS associated with the first wireless device;
determining whether to initiate the UL MU-OFDMA transmission based on the reduced MCS; and
triggering the UL MU-OFDMA transmission based on the determination.

2. The method of claim 1, further comprising:
determining a payload size associated with each of the wireless devices; and
determining a receive power value associated with each of the wireless devices, wherein the determination of the MCS for each of the wireless devices is based on the payload size and the receive power value, and wherein the allocation of the RUs to each of the wireless devices is further based on the payload size.

3. The method of claim 1, wherein the determination of whether to initiate the uplink OFDMA transmission based on the reduced MCS includes performing a second power imbalance check for each of the wireless devices based on the reduced MCS.

4. The method of claim 3, further including, responsive to determining that the first wireless device failed the second power imbalance check:
determining whether the reduced MCS is a lowest MCS; and
responsive to determining that the reduced MCS is not the lowest MCS, further reducing the MCS associated with the first wireless device and determining whether to initiate the UL MU-OFDMA transmission based on the further-reduced MCS; and
responsive to determining that the reduced MCS is the lowest MCS, removing the first wireless device from the number of wireless devices to participate in the UL MU-OFDMA transmission.

5. The method of claim 4, further including, responsive to removing the first wireless device, increasing a size of an RU allocated to a selected second wireless device of the wireless devices participating in the UL MU-OFDMA transmission using tones from the RU previously allocated to the first wireless device.

6. The method of claim 4, further including, responsive to removing the first wireless device:
identifying one or more other wireless devices not currently participating in the UL MU-OFDMA transmission; and
allocating an RU to a selected second wireless device of the other wireless devices using tones in the RU previously allocated to the first wireless device.

7. The method of claim 6, wherein the second wireless device is selected based on a received signal strength indication (RSSI).

8. The method of claim 4, further including:
determining a measure of a bandwidth efficiency of the UL MU-OFDMA transmission;
determining whether to initiate the UL MU-OFDMA transmission based on the determined bandwidth efficiency; and
triggering the UL MU-OFDMA transmission based on the determination.

9. The method of claim 3, wherein reducing the MCS associated with the first wireless device includes reducing the MCS to a second MCS estimated to pass the second power imbalance check.

10. A wireless communications device comprising:
at least one antenna;
a processor; and
a memory communicatively coupled with the processor and storing processor-readable code that, when executed by the processor, causes the wireless communications device to:
identify a number of wireless devices to participate in an uplink multi-user orthogonal frequency division multiple access (UL MU-OFDMA) transmission;
determine a modulation and coding scheme (MCS) for each of the wireless devices to use for the UL MU-OFDMA transmission;
allocate a resource unit (RU) for the UL MU-OFDMA transmission to each of the wireless devices based on the associated MCS;
perform a receive power imbalance check for each of the wireless devices based on the allocation of the RUs and the MCS associated with the respective wireless device;
responsive to determining that a first wireless device of the wireless devices failed the power imbalance check, reduce the MCS associated with the first wireless device;
determine whether to initiate the UL MU-OFDMA transmission based on the reduced MCS; and
trigger the UL MU-OFDMA transmission based on the determination.

11. The wireless communications device of claim 10, wherein the processor-readable code is further configured to cause the wireless communications device to:
determine a payload size associated with each of the wireless devices; and
determine a receive power value associated with each of the wireless devices, wherein the determination of the MCS for each of the wireless devices is based on the payload size and the receive power value, and wherein the allocation of the RUs to each of the wireless devices is further based on the payload size.

12. The wireless communications device of claim 10, wherein the determination of whether to initiate the uplink OFDMA transmission based on the reduced MCS includes performing a second power imbalance check for each of the wireless devices based on the reduced MCS.

13. The wireless communications device of claim 12, wherein the processor-readable code that is further configured to cause the wireless communications device to, responsive to determining that the first wireless device failed the second power imbalance check:
determine whether the reduced MCS is a lowest MCS; and
responsive to determining that the reduced MCS is not the lowest MCS, further reduce the MCS associated with the first wireless device and determining whether to initiate the UL MU-OFDMA transmission based on the further-reduced MCS; and
responsive to determining that the reduced MCS is the lowest MCS, remove the first wireless device from the number of wireless devices to participate in the UL MU-OFDMA transmission.

14. The wireless communications device of claim 13, wherein the processor-readable code is further configured to cause the wireless communications device to, responsive to removing the first wireless device, increase a size of an RU allocated to a selected second wireless device of the wireless devices participating in the UL MU-OFDMA transmission using tones from the RU previously allocated to the first wireless device.

15. The wireless communications device of claim 13, wherein the processor-readable code is further configured to cause the wireless communications device to, responsive to removing the first wireless device:
identify one or more other wireless devices not currently participating in the UL MU-OFDMA transmission; and
allocate an RU to a selected second wireless device of the other wireless devices using tones in the RU previously allocated to the first wireless device.

16. The wireless communications device of claim 15, wherein the second wireless device is selected based on a received signal strength indication (RSSI).

17. The wireless communications device of claim 13, wherein the processor-readable code is further configured to cause the wireless communications device to:
determine a measure of a bandwidth efficiency of the UL MU-OFDMA transmission;
determine whether to initiate the UL MU-OFDMA transmission based on the determined bandwidth efficiency; and
trigger the UL MU-OFDMA transmission based on the determination.

18. The wireless communications device of claim 12, wherein reducing the MCS associated with the first wireless device includes reducing the MCS to a second MCS estimated to pass the second power imbalance check.

19. A tangible computer-readable storage medium comprising non-transitory processor-executable code operable to:
identify a number of wireless devices to participate in an uplink multi-user orthogonal frequency division multiple access (UL MU-OFDMA) transmission;
determine a modulation and coding scheme (MCS) for each of the wireless devices to use for the UL MU-OFDMA transmission;
allocate a resource unit (RU) for the UL MU-OFDMA transmission to each of the wireless devices based on the associated MCS;
perform a receive power imbalance check for each of the wireless devices based on the allocation of the RUs and the MCS associated with the respective wireless device;
responsive to determining that a first wireless device of the wireless devices failed the power imbalance check, reduce the MCS associated with the first wireless device;
determine whether to initiate the UL MU-OFDMA transmission based on the reduced MCS; and
trigger the UL MU-OFDMA transmission based on the determination.

20. The computer-readable storage medium of claim 19, further including processor-readable code to:
determine a payload size associated with each of the wireless devices; and
determine a receive power value associated with each of the wireless devices, wherein the determination of the MCS for each of the wireless devices is based on the payload size and the receive power value, and wherein the allocation of the RUs to each of the wireless devices is further based on the payload size.

21. The computer-readable storage medium of claim 20, wherein the determination of whether to initiate the uplink OFDMA transmission based on the reduced MCS includes performing a second power imbalance check for each of the wireless devices based on the reduced MCS.

22. The computer-readable storage medium of claim 21, further including processor-readable code to, responsive to determining that the first wireless device failed the second power imbalance check:
determine whether the reduced MCS is a lowest MCS; and
responsive to determining that the reduced MCS is not the lowest MCS, further reduce the MCS associated with the first wireless device and determining whether to initiate the UL MU-OFDMA transmission based on the further-reduced MCS; and
responsive to determining that the reduced MCS is the lowest MCS, remove the first wireless device from the number of wireless devices to participate in the UL MU-OFDMA transmission.

23. The computer-readable storage medium of claim 22, further including processor-readable code to, responsive to removing the first wireless device, increase a size of an RU allocated to a selected second wireless device of the wireless devices participating in the UL MU-OFDMA transmission using tones from the RU previously allocated to the first wireless device.

24. The computer-readable storage medium of claim 22, further including processor-readable code to, responsive to removing the first wireless device:
identify one or more other wireless devices not currently participating in the UL MU-OFDMA transmission; and
allocate an RU to a selected second wireless device of the other wireless devices using tones in the RU previously allocated to the first wireless device.

25. The computer-readable storage medium of claim 24, wherein the second wireless device is selected based on a received signal strength indication (RSSI).

26. The computer-readable storage medium of claim 22, further including processor-readable code to:
determine a measure of a bandwidth efficiency of the UL MU-OFDMA transmission;
determine whether to initiate the UL MU-OFDMA transmission based on the determined bandwidth efficiency; and
trigger the UL MU-OFDMA transmission based on the determination.

27. The computer-readable storage medium of claim 21, wherein reducing the MCS associated with the first wireless device includes reducing the MCS to a second MCS estimated to pass the second power imbalance check.
